(19) United States
(12) Patent Application Publication
(10) Pub. No.: US 2008/0249861 A1
(43) Pub. Date: Oct. 9, 2008

(54) Bonus system

(75) Inventors: Marcus Carotta, Munchen (DE); Markus Kleinfelder, Starnberg (DE); Dirk Lenzkes, Dusseldorf (DE); Othmar Klaassen, Moers (DE); Dirk Schreib, Dusseldorf (DE)

Correspondence Address: FROST BROWN TODD, LLC, 2200 PNC CENTER, 201 E. FIFTH STREET, CINCINNATI, OH, 45202, US

(73) Assignee: Loyalty Partner GmbH, Munchen (DE)

(21) Appl. No.: 11/775,265

(22) Filed: Jul. 10, 2007

(30) Foreign Application Priority Data
Apr. 5, 2007 (DE) DE102007016609

(51) Int. Cl. G06Q 30/00

(52) U.S. Cl. 705/14

(57) ABSTRACT

A computer program product comprising program code, stored on a machine readable medium, or provided in the form of a propagated signal, wherein the program code, when executed on a computer system, implements a bonus system, and allows the customizable establishment of bonus programs. Several bonus program partners can participate in a bonus program. Bonus program members can collect bonus points in transactions with a bonus program partner. The bonus program comprises the following functions: defining, activating, and deleting a bonus program within the bonus system; defining individual bonus program properties and bonus program rules; defining, activating, and deleting bonus program partners; settling with bonus program partners; and establishing properties of bonus program accounts.

### FIELD OF THE INVENTION

The present invention relates to bonus system in general, and in particular to a computer program product implementing such a bonus system, and to a computer system for hosting such a bonus system.

### BACKGROUND OF THE INVENTION

Computer based customer retention systems, in which customers can collect bonus points in business transactions are known e.g. from WO 99/20013 and EP 1 134 677 A1.

Since the implementation and execution of such a bonus system is generally complex and requires special know-how, many businesses have decided not to establish their own individual bonus systems, but have joined existing bonus systems of external customer retention service providers. Some bonus systems of external customer retention service providers allow the combination of several businesses in the same “bonus program”. The applicant has been operating for several years as an external customer retention service provider, and has created the well known customer retention system PAYBACK® for this purpose.

With this background, the object of the present invention is to refine such bonus systems technically for wider use.

### SUMMARY OF THE INVENTION

The invention relates to a computer program product, comprising program code, stored on a machine readable medium, or provided in the form of a propagated signal, wherein the program code, when it is executed on a computer system, establishes a bonus system, allowing the customizable establishment of bonus programs, wherein several bonus program partners can participate in a bonus program, and wherein bonus program members can collect bonus points in transactions with a bonus program partner. The bonus system comprises the following functions: defining, activating, and deleting a bonus program within the bonus system; defining individual bonus program features and bonus program rules; defining, activating, and deleting of bonus program partners; settling with bonus program partners; and establishing features of bonus point accounts.

An additional aspect relates to a computer system for hosting a bonus system, allowing the customizable establishment of bonus programs, wherein several bonus program partners can participate in a bonus program, and wherein bonus program members can collect bonus points in transactions with a bonus program partner. The bonus system comprises the following functions: defining, activating, and deleting a bonus program within the bonus system; defining individual bonus program features and bonus program rules; defining, activating, and deleting of bonus program partners; settling with bonus program partners; and establishing features of bonus point accounts.

Further features are included in the disclosed devices and methods, or can be derived by a person skilled in the art from the following detailed description of embodiments and from the appended drawings.

### BRIEF DESCRIPTION OF THE DRAWINGS

Embodiments of the invention are now described in an exemplary manner with reference to the appended drawings, wherein:

FIG. 1 is a diagram showing the context between a bonus system, bonus program partners, and bonus program members;

FIG. 2 is an illustration of a bonus point account file;

FIG. 3 is a diagram showing the funds and bonus point flows between members, partners, and the bonus system provider;

FIG. 4 is a diagram for illustrating the customization capability of the computer program;

FIG. 5 is a diagram similar to FIG. 4 for illustrating further customization options of the computer program;

FIG. 6 illustrates a super bonus program and its transfer, when instantiating bonus programs;

FIG. 7 is a diagram illustrating the capability of the computer program to transfer bonus points, collected in a bonus program, to another bonus program; and

FIG. 8 is a diagram depiction of an embodiment of a bonus computer system.

### DESCRIPTION OF THE PREFERRED EMBODIMENTS

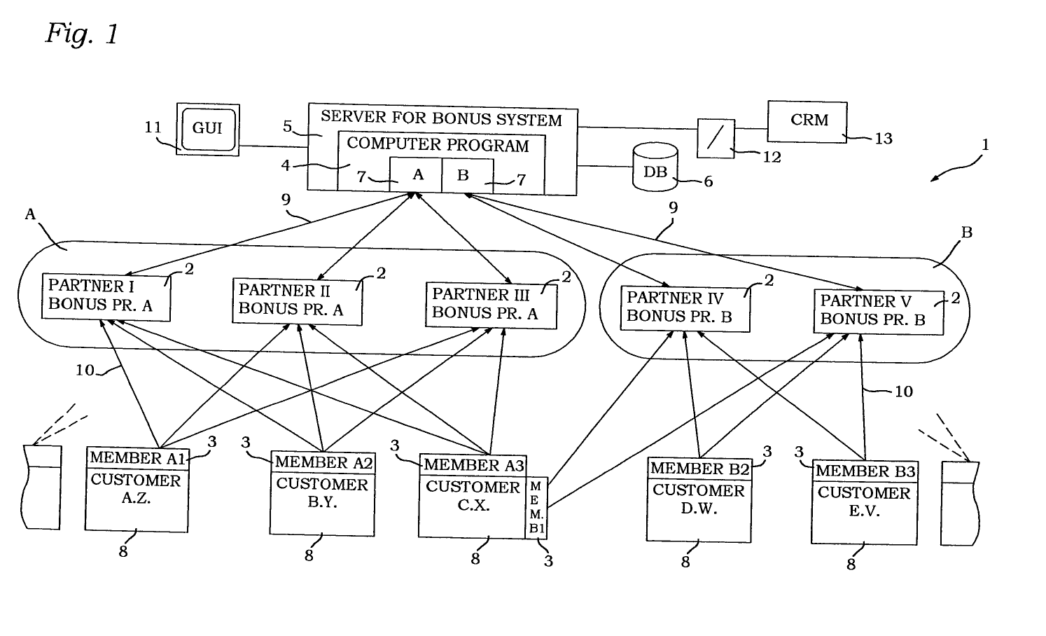

FIG. 1 illustrates the interrelations between a bonus system, bonus program partners, and bonus program members in an abstract depiction. Previous to a detailed description of FIG. 1, and of the other figures, various descriptions with respect to the embodiments will be given.

Initially, the terminology employed herein shall be described. Going from general to particular, initially the term “bonus system” shall be addressed; it comprises the entire functionality of the computer program described herein. The bonus system can comprise several so-called “bonus programs”. In a bonus program, several different vendors (e.g. vendors of products and services) can grant bonuses to their customers, who can collect and redeem them for all vendors combined. Thus in a bonus program, several vendors act as a unit with reference to the bonuses; in the extreme a “bonus program”, can however comprise only one vendor. The vendors, which belong to the same bonus program, are called “partners of the bonus program” or briefly “bonus program partners” in the present description. Their customers, who collect bonus points, associated with the bonus program in a transaction, thus e.g. a purchase, or the use of a service, are called members of the bonus program or abbreviated “bonus program members”.

While in the past mostly customer retention service providers have provided the participation in a single bonus program for as many “partners” as a service, as possible, and have directed their main development activity towards the ongoing increase of the attractiveness of their bonus program, the present embodiments represent a computer program, allowing the establishment of a bonus program in a customizable manner, or of several bonus programs in parallel to each other. A business, which does not want to rely on an external service provider, but wishes to establish a bonus system for their own purposes, or wishes to offer the operation of a bonus system as a service for third parties, does not have to implement this itself anymore, but only has to customize the subsequently defined computer program, wherein, as mentioned above, it is even possible to establish, or offer several bonus programs in parallel.

For this purpose, the embodiments of the computer program allow defining a bonus program, activating it, and deleting it, without having to change the particular computer program code of the bonus system. They furthermore allow defining individual bonus program features and bonus program rules for the different bonus programs, and thus, through specification of parameters and/or entry of rules, again without having to change the particular computer program code of the bonus system. The embodiments furthermore provide the typical base functions of bonus systems, in particular, the ability for establishing and operating bonus program accounts for the members and the capability for the members to be able to collect bonus points and use the collected bonus points, e.g. redeem them. In several embodiments, it is additionally possible, that bonus point accounts can be established and operated for a member in several bonus point currencies. At the level of the bonus program partners, the embodiments, furthermore, provide typical base functions, e.g. the capability to define bonus program partners, activate, manage, and delete them, e.g. when partners enter a program or e.g. when partners exit a program, and the settlement with the bonus program partner. With respect to the last point, it is appreciated that the provider of a bonus system generally receives compensation from the partners for the service of providing and executing the bonus system. In some embodiments, the provider of the bonus system is also responsible for paying out the bonuses to the members in case of cash bonuses, or to initiate their delivery in case of bonus objects; also for this, he receives compensation from the partners. The accounting for these compensations thus is also part of the bonus system.

The embodiments thus allow the operation of several bonus programs on the same platform, this means on the same server, or on the same group of cooperating servers, and on the same operating system.

In some embodiments, defining the particular bonus programs is facilitated in that they are in a “super program relationship” with each other. This means that, when instantiating a bonus program, several or all properties of the bonus program are taken over from a predefined or pre-definable “super bonus program”. For many applications, this forms a useful starting point for further customization; in the context of a further refinement then an individualization of the particular bonus programs is possible by defining program specific properties for them, which deviate from the super bonus program, or which are not predetermined by it. Alternatively, the bonus programs can also be defined independently from each other right from the beginning.

In certain embodiments the computer program is provided, so that the bonus system can transmit data regarding bonus program members to the CRM system through an interface to a customer relationship management system (CRM system), or can receive data from it. For example, data regarding the purchasing habits of members can be generated with a bonus system, which can be combined with the data typically available in a CRM system.

Subsequently, the customizability of different bonus program properties is described in more detail in an exemplary manner. In some embodiments, the bonus system implemented by the computer program allows a definition of the bonus program properties with respect to one or several of the following points (a)-(g) without having to change the computer program code of the bonus system:

(a) Establishment of rules for account administration: this relates to the definition of properties of accounts of the bonus program members for collecting bonus points, e.g. types of points can be defined, e.g. status points, points improving the “status” of a member, or payout points, points, which are e.g. converted into cash and paid out, as well as, various point categories, as e.g. points earned in transactions, or bonus points, e.g. donated points, so-called goodwill points. Anonymous accounts can be allowed, or not be allowed, these are e.g. accounts which can already be used before the registration of a new member. Also, the account expiration can be defined in some embodiments, e.g. an account can automatically expire after a certain time span of non activity. Alternatively, it can be defined, that an account can expire through explicit deletion.

(b) Definition of account and transaction semantics, in order to be able to customize the bonus system for different kinds of business, it is provided in some embodiments that the designation of the attributes of accounts and transactions, thus their “semantics” can be selected freely. Thus it will e.g. be useful to establish the transaction attribute “distance flown” with a program partner “airline”, which would not have a sensible meaning with a partner “product distributor”. Correspondingly, with the latter, a transaction attribute “food/non food” can be established with the latter, which would not be sensible for an airline.

(c) Establishment of rules for collecting, redeeming, and for the expiration of bonus points: for defining a bonus program, it is provided in some embodiments that rules regarding bonus points can be established. These rules can e.g. define initially, how bonus points are collected, thus in which transactions which kinds of bonus (e.g. status points or points to be redeemed) are being “earned” in which quantity, e.g. in a certain relationship to the purchase price. Additional rules relate to the redemption of such points, e.g. from which minimum number of points a cash or product bonus is available; or in case of status points, after which number of points status changes occur. Eventually, there are rules in some embodiments regarding the expiration of bonus points, thus, if, and after which time period non redeemed bonus points expire.

(d) Establishment of rules for exchanging bonus points between bonus programs (inter program exchange): in some embodiments, it is provided, that members can transfer their bonus points earned, within a bonus program, into another bonus program. In order to define this functionality, in some embodiments, rules can be established in the context of the customization of the computer program, if, and possibly how bonus points are exchangeable between bonus programs. These rules can e.g. relate to the “exchange rate”, when exchanging points or conditions with respect to the minimum or maximum amount and the minimum or maximum age of exchangeable bonus points. When both (or all) programs, between which points are exchangeable, reside on the same platform, the entire exchange process can be defined during the customization of the bonus program, and the exchange itself can be performed within the platform. In case the respective bonus programs reside on different platforms, the point exchange is typically accomplished through the exchange of data between the different platforms, which include information regarding the bonus points to be exchanged. In this case, the rules also serve for the definition, which of the participating platforms takes over which part of points processing, and further tasks, like e.g. rule testing; also, format and meaning (semantics) of the data in the files to be exchanged can be defined through rules.

(e) Establishment of a status concept for bonus program members: in some embodiments, a member can have several membership statuses, e.g. a bronze status, a silver status, or a gold status. Which status a member receives can depend e.g. on the absolute balance of bonus points, or on the bonus points acquired over a certain period of time, or similar. In some embodiments, points of a certain type are used as a basis for status allocation, e.g. so-called status points. For customizing a bonus program, a status concept for the bonus program members can be established, through which it is defined, which different status shall be present, which transition concept shall be applicable, this defines, which target status can be reached from which initial status, with which number of points of which type the particular status can be reached, if and also how this possibly depends on special membership attributes, how the temporal dependencies, e.g. influence of seniority of membership or of the age of points, etc., if and how the status history is considered, e.g. if there is a simplified requalification for a lost status within a certain time interval.

(f) Definition of number schemes for cards and other authentication means: for the identification of members, a so-called alias is used, thus a unique identification number. An alias can be a number identifying a member, which is visible for the member, and which appears e.g. on his membership card. Alternatively, the alias can be an identification number, which is not visible for the member, and which is only used internally in the context of the bonus program; another identification number identifying the member can then be depicted onto the alias. The alias, or another number to be depicted onto the alias can e.g. be included on a membership card or on a credit card, or in other authentication means, like e.g. an RFID chip in a mobile phone. The alias can also be formed through a simple membership number, which is imprinted on another card, e.g. a customer card issued by the bonus partner. In some embodiments, the alias identification number can be structured by being separable into segments, and a certain meaning, semantic being allocable to each segment. In some embodiments, therefore, number schemes for cards and other authentication means can be defined in the context of the customization of bonus programs. For example, an identification number of the respective bonus program, an identification number of the bonus partner, which has accepted the member, and status information with respect to the member, can be coded into the alias identification number, besides other data, which e.g. relate to the generation of the alias identification number, or constitute check numbers, etc. During the definition of such a number scheme in the context of the customization, it can e.g. be specified, how the alias identification number is segmented, and what the particular segments mean.

(g) Defining basic conditions for services: some embodiments also allow the handling of supplementary services, as e.g. sending membership magazines or advertising to the members. Some embodiments allow to define basic conditions for such services in the context of the customization of a partner program. This can e.g. include a definition, which services are available. Furthermore, the definition of subscription rules is possible, thus, if a membership magazine is sent to a member after his registration, or if this only occurs after the member has subscribed to it.

As it has already been addressed, the computer program is set up in some embodiments, so that bonus program members can redeem collected bonus points for bonuses, wherein the different available bonuses and the conditions necessary for their receipt, can e.g. be defined in the context of the customization.

Bonus accounts can e.g. be operated in a real currency (e.g. Euros); alternatively, the accounts can also be operated in a virtual currency (e.g. bonus points of a certain bonus program). In some embodiments, the computer program is set up so that the members can operate parallel accounts in various bonus currencies. The bonus program members can interrogate account status information, e.g. their account balances in various bonus currencies, through a suitable interrogation, e.g. through a web access. The definition, if, and possibly how many accounts can be operated in parallel, and which bonus currencies are available for it, can be defined in the context of the customization process.

In some embodiments, it can be defined in a free manner through rules, how the bonus points, which a member receives, are being calculated, e.g. based on a certain fixed percentage of the sales generated in a transaction, and how these bonus points are accounted for, thus e.g. into which of the parallel accounts the booking is performed, e.g. depending on the kind of the transaction, the current status of the member, etc.

In some embodiments, the computer program is set up, so that it allows to define the expiration of bonus points in the context of the customization, which are not being used. It can e.g. be defined that bonus points, which are not being used expire after a certain time, depending on the bonus program rules established during the customization, considering bonus point type, bonus point category, member status, etc.

In some embodiments, during the customization, also a determination is possible that bonus points can be defined in one or several point currencies. These are e.g. points, which are added in certain transactions as an add-on, or which are issued without dependence on a transaction in the context of marketing campaigns, etc.

In some embodiments, the computer program is set up, so that members can interrogate the currently available bonuses, e.g. product bonuses, via a web interface, including the necessary number of bonus points.

In some embodiments, various types of bonus program partners can be defined. In the most simple partner type, the partner is only authorized to issue bonus points. Another “higher” partner type can also provide disbursements for collected points, e.g. in the form of discounts, which a member receives for product purchases from the partner, and which lead to a corresponding reduction of the bonus point account of the member. In another type, the partner is allowed to issue minimum membership identifications, thus the aliases mentioned above. This is interesting in particular for partners, who want to issue their own customer cards or similar, which are provided with the logo of the respective partner for the participation of the members in the bonus program.

A partner typically has a large number of business locations. A business location forms a so-called point of sale (POS). This can e.g. be an outlet with several cash registers, or other billing devices. But it is also possible, that each cash register/billing location forms a business location of its own. In some embodiments of the computer program, the business locations of the partners and their characterizing attributes can be defined during the customization process. These attributes comprise, on the one hand, general attributes, like name, address, business hours, date of foundation, type of business location, bank account, and contact person of the business location. On the other hand, the attributes can comprise bonus program specific attributes, e.g., if, and over which channels the business location shall be made visible to the members, if the business location can issue aliases, if the business location can issue anonymous alias, and possibly how many of those, and/or if the business location accepts aliases, wherein the latter point can be relevant in particular with partners with a franchise concept. Through such an establishment of business locations, the program is e.g. capable to inform members of a bonus program, and possibly third parties about the most proximal business location. In addition, business location based bonus account bookkeeping and statistics are often useful.

As already mentioned above, the computer program is suitable amongst others, also for service providers, who want to offer the execution of the bonus system implemented with the computer program as a service to partners, thus third party businesses. For this service, the partners have to generally have to pay a compensation to the service provider. The services to be paid for with a compensation will comprise a bookkeeping with respect to issuing bonus points through the partners, collecting bonus points on bonus accounts, and redeeming bonus points through the member, or if the partner redeems points, the accounting for such redemptions by partners. Further billable services can be e.g. canceling transactions or services in the context of campaigns. Expiring bonus points can be reimbursed entirely or partially to the initially issuing partner. In some embodiments, attributes and properties of billing can be defined with the partners in the context of a customization process; this means, in particular, that the compensation for the said services can be defined.

In some embodiments, the computer program is also provided, so that marketing campaigns can be managed in the context of the bonus system. Campaign management allows e.g. to define the name of a campaign. Another definition possibility e.g. relates to the manner and the time of publishing the campaign; typically, a campaign is communicated to a certain subgroup of partners of the respective bonus program with a certain lead time. Also, the activation period of a campaign can be defined, thus the time of its beginning and its duration. In some campaigns, a registration period takes place before the real beginning of the campaign, in which registration period, the members can register for participation. The beginning and/or the duration of this registration period can then also be defined. Furthermore, the type of transaction, which is promoted in the campaign, can be defined, thus the kind of goods, business locations, transaction times, etc., in which the member receives a reward. Furthermore, the kind of reward(s) can be defined, which are issued in the context of the campaign. Finally, it can also be defined, which member groups shall be allowed to participate in the campaign.

In some embodiments, the computer program is provided, so that the establishment of new members can be defined through rules in the context of the customization process. These rules define e.g., if a partner is allowed to register new members, if the registration of a member in one program also implies an automatic registration as a member in one or several other programs, and if an alias and a membership card are automatically given to the member with the registration. The rules also relate to groups of numbers, which are available to the particular partners for the allocation of aliases. In some embodiments, there are also rules for further authentication means, e.g. rules, defining the password policy. They define e.g. minimum requirements with respect to the number and type of signs to be used for valid passwords, as well as, time based rules for the renewal of passwords, etc.

In some embodiments, also a function in the context of the customization can be activated, allowing several members to collect points in a joint bonus point account. Such function can be very socially advantageous, e.g. allowing members to provide the bonus points collected by them to a charitable organization; the joint bonus account will then be disbursed to the charitable organization.

In some embodiments, the computer program is eventually also provided, so that one or several data test- or purging functions can be defined from the following list in the context of customization:

Identification and consolidation of double memberships: since it occurs again and again that a customer registers as a member several times, e.g. when he does not have the access data of his already existing membership available, an ongoing examination of the current members is performed with respect to double membership. If such double membership is identified, an automatic consolidation of such double memberships can be provided. Alternatively, it is possible, that in one case a service specialist contacts the member and only performs the consolidation, when the assumed double membership was verified due to the established contact.

Identification and consolidation of joint households: since knowledge about a member living alone or together with one or several other members in a joint household, can e.g. be valuable for marketing campaigns, in some embodiments, also a function for identifying joint households of members can be established. As in the above explained case of double memberships, the consolidation with respect to joint households can be performed automatically or alternatively after contacting and verification through a service specialist.

Checking of mailing addresses, telephone numbers, and/or bank information: in existing zip code-, address- and telephone registers, consistency checks of the respective information obtained from members can be performed. Accordingly, bank data can be checked for accuracy through enquiries at the respective banks. In some embodiments, third party data quality systems are included in the computer program for the data check and consolidation functions, e.g. an address quality system. The said checks can be performed in some embodiments selectively through the computer program, possibly through the involved quality systems, or through the use of specialized external service providers. In some of these embodiments, it is provided that the scope of the respective check functions can be defined in the context of the customization.

Some of the embodiments of the registered computer program are embodied e.g. in the form of a computer program product, which comprises program codes for the execution of the respective methods. This program code is stored e.g. on or in a machine readable medium. The designation “machine readable medium” comprises e.g. semiconductor memories and removable and non removable optical and magnetic storage media. In other embodiments, the computer program is provided downloadable from a network, e.g. the internet. In these embodiments, the computer program product can thus be considered as a propagated signal, comprising a representation of the program code. The signal is carried by an electromagnetic wave, e.g. a radio wave, which is transmitted via a copper cable, and transmitted through the air, or a light wave, which is transmitted through a light wave conductor. The program code can be machine code or another code, which can be converted into machine code, e.g. source code in a multipurpose programming language, e.g. C, C++, Java, C#, etc. The embodiments of the computer system are e.g. multipurpose computers, which are programmed in the said program code.

Returning now to FIG. 1, it shows a bonus system 1 in a schematic manner, and the context between the bonus system 1, bonus program partners 2, and bonus program members 3. A computer program 4 which implements the bonus system 1 runs on a server 5. This among other things is coupled with a database 6 for storing the data in the context with the bonus system 1.

In the embodiment shown in FIG. 1, the computer program 4 is set up in the context of a customization process, so that it provides two bonus programs 7, designated with “A” or “B”.

To each of the bonus programs 7, one or several bonus program partners 2 are assigned. The bonus program partners 2, which are numbered in FIG. 1 with capital Roman numbers, are e.g. merchants and/or service providers, which try to retain their customers 8 through the participation in a bonus program 1, wherein several partners 2 jointly participate in a bonus program 7, in the example of FIG. 1. The participation in such a bonus program 7 with many partners makes the bonus system 1 more attractive for customers, since it allows them to accumulate bonus points from transactions with all partners 2 of the respective bonus program (A or B), and thereby to obtain bonuses in a simpler and faster manner.

In the example of FIG. 1, the partners I-III are participants in the bonus program A, and the partners IV and V are participants in the bonus program B. Between the server 5 and the partners 2, there are secure data connections 9, e.g. via the internet or via point to point connections, over which, on the one hand, the partners 2 report transaction related data to the server 5, while, on the other hand, data (mostly data relating to the administration of the bonus system 1) flow from the server 5 to the partners 2. For the capture of the transaction related data, their transmission to the server 5 and the reception of said data from it, a suitable computer system is provided at each of the partners 2, so that from a technical point of view the partners 2 shown in FIG. 1 are computer systems suitable and provided for these tasks.

The customers 8 are real world entities, thus e.g. persons or entities acting like persons, e.g. companies, persons, or public companies, government agencies, etc., which can perform business transactions, thus purchase e.g. goods or services. In FIG. 1, these customers are shown in a symbolic manner through two name initials. Each of the illustrated customers 8 can here be a member of one or several of the bonus programs 7. E.g. the customers A.Z. to C.X. are members in the bonus program A, while the customers D.W. and E.V. are members in the customer program B. Since it is typically allowed by a bonus system 1 of the shown kind, that a customer is a member of several bonus programs, FIG. 1 shows in an exemplary manner that the customer C.X. is a member in the bonus program A (designated therein with “A3”), and also a member in the bonus program B (designated therein with “B1”). The connections designated as 10 in FIG. 1 between the members 3 and the partner 2 belonging to the respective bonus program 7 symbolize transactions, through which the respective member 3 can collect bonus points. These can also be data connections between the members 3 and the partners 2, e.g. when the said transactions are performed on the internet, e.g. purchase of a product by the member 3 in an online shop of the partner 2. Alternatively, the transactions 10 can also be conventional transactions of the member 3, physically present at the business location of the partner 2, thus these are conventional purchasing operations.

The bonus programs A and B implemented by the computer program 4 are institutions of a more abstract type “bonus program”, provided by the computer program 4. The bonus programs A and B run on the same platform, this means on the same server 5 under the same operating system.

In order to be able to adapt the computer program 4 to the specific requirements of various bonus programs, this means “customize” them, and also to be able to perform ongoing adaptation, administration, and maintenance tasks through a suitable technician, the server 5 is coupled with a graphic user interface (GUI) 11.

Furthermore, the server 5 is coupled with a CRM system 13 (Customer Relationship Management System) through an interface 12, which in turn can be part of an ERP (Enterprise Resource Planning) application, like e.g. SAP. Via the interface 12, e.g. a data exchange between the stored and collected data in the context of the bonus system 1, and the data of the CRM system 13 can take place. The base data of customers 8 (name, address, etc.) can have been captured first in the CRM system 13, either only for the purpose of a transfer to the computer program 4, or for the permanent storage in the CRM system 13 with an on demand access by the computer program 4 via the interface 12.

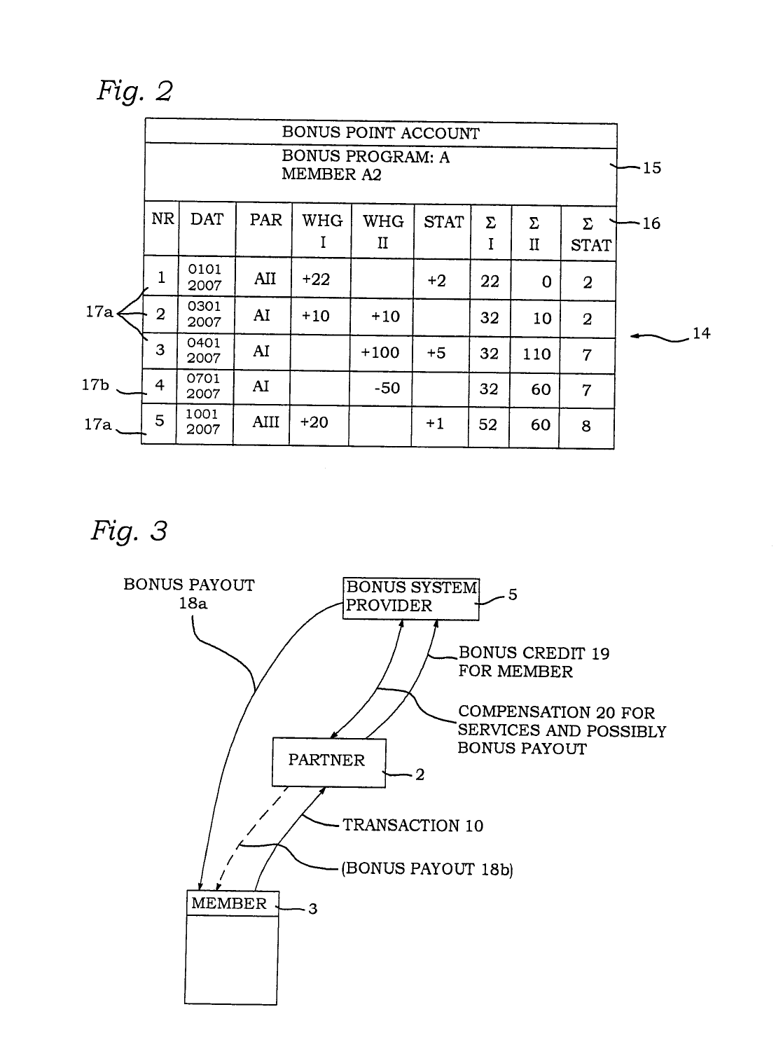

FIG. 2 is a depiction of a bonus point account file, representing the bonus point account of a member, operated by the bonus system provider. In a relational database system, the bonus point account is represented through a relation, which can be represented through a table, in this case the table 14 of FIG. 2. In 15 it is illustrated, to which bonus program, and to which member the account 14 is related. Each bonus relevant transaction is represented by a dataset 17. This in return is comprised of a number of data elements, which belong to various attributes 16, and which define the respective transaction more closely. The attributes 16 comprise e.g. the date of the transaction (“DAT”), the partner, at which the respective transaction was performed (“PAR”), the number of the bonus points credited or subtracted in the transaction in one or several currencies (here in two currencies, “WHG I” and “WHG II”) and status points (“sum I”, “sum II”, or “sum STAT”). In the table 14, shown in FIG. 2, it is also assumed that the account balances, thus the accumulated bonus points in the particular currencies and the accumulated status points, are zero initially. The points received in a transaction can e.g. be a fixed percentage of the purchase price of the goods purchased in a transaction, e.g. for each euro or dollar of purchase price a bonus point can be awarded, which e.g. has the value of one cent, when a bonus is paid out. Depending on certain parameters of the transaction, e.g. depending on the partner, the type of product purchased, the location, or the time of the transaction points in various point currencies can be earned, wherein it is possible, that the transactions are pure in currency, this means only points in a certain currency are being earned, or the transactions are mixed in currency, this means that during transaction points are earned in several different currencies. The currencies can differ e.g. in their conversion factor for point allocation or bonus allocation. In the example of FIG. 2, four datasets 17a are depicted, in which the respective member earns points. Furthermore, an additional dataset 17b is illustrated, which represents a bonus payout; accordingly the account balance of the member with respect to the point currency is reduced, in which the payout has been performed. The accounts 14 of the type shown in FIG. 2 are operated by the computer program 4 in the server 5 in the database 6.

FIG. 3 illustrates possible money and bonus point flows between members 3, partners 2, and the bonus system provider 5 in some embodiments. A member 3 performs a transaction 10 at a partner 2. The partner 2 subsequently reports the data of the transaction 10 through his data connection 9 (FIG. 1) to the bonus system provider 5, who subsequently initiates a point credit according to FIG. 2, corresponding to the transaction on the bonus account of the member. The report of the transaction data and the point credit are designated with “19” in FIG. 3. In other embodiments, the partner 2 already determines which and how many points are to be credited to the customer due to the transaction, and only reports the point data instead of the transaction data to the bonus system provider at 19. A bonus payout to the member 3 is performed now and then by the bonus system provider 5, e.g. in the form of a cash or product bonus. Alternatively, the bonus payout can also be performed by a partner 2 of the bonus program to the member 3, which is illustrated in FIG. 3 through a dashed arrow, designated “18b”. The partners 2 eventually pay a compensation 20 to the bonus system provider 5 for the points credited in the context of transactions at these partners 2, as well as, services performed by the partner “executing bonus system”, and in some bonus programs, the partners receive a compensation for bonuses paid out, depending on who performs the bonus payout.

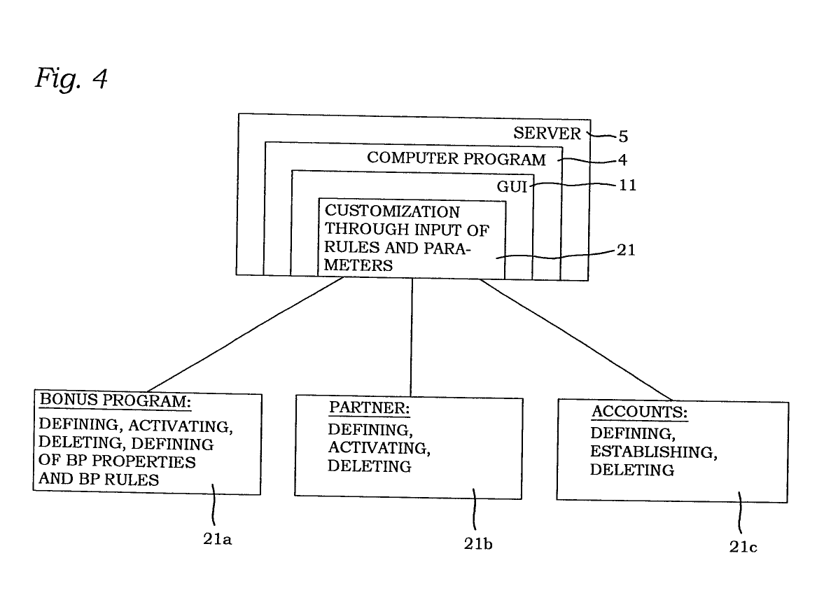

FIG. 4 illustrates the customization capability of the computer program 4 operating on the server 5. This computer program provides a graphic user interface through the graphic user interface 11, e.g. to a system administrator, e.g. in the form of a window 21, in which the system administrator can customize the computer program 4 through the entry of rules and parameters 21, regarding the runtime, thus without new compiling. In the embodiment, illustrated in FIG. 4, different windows 21a through 21c are provided for the customization of the various sub aspects of the bonus system. The customization window 21a allows e.g. the entry of rules and parameters regarding the respective bonus program, e.g. those for defining, activating and deleting of bonus programs, and furthermore, rules and parameters for defining additional bonus program properties. The customization window 21b relates to the various parameters and allows defining, activating and deleting partners accordingly. The customization window 21c relates to bonus accounts, it allows defining account types, establishing them, and deleting them, and to define establish and delete particular accounts (thus institutions of the account types) accordingly.

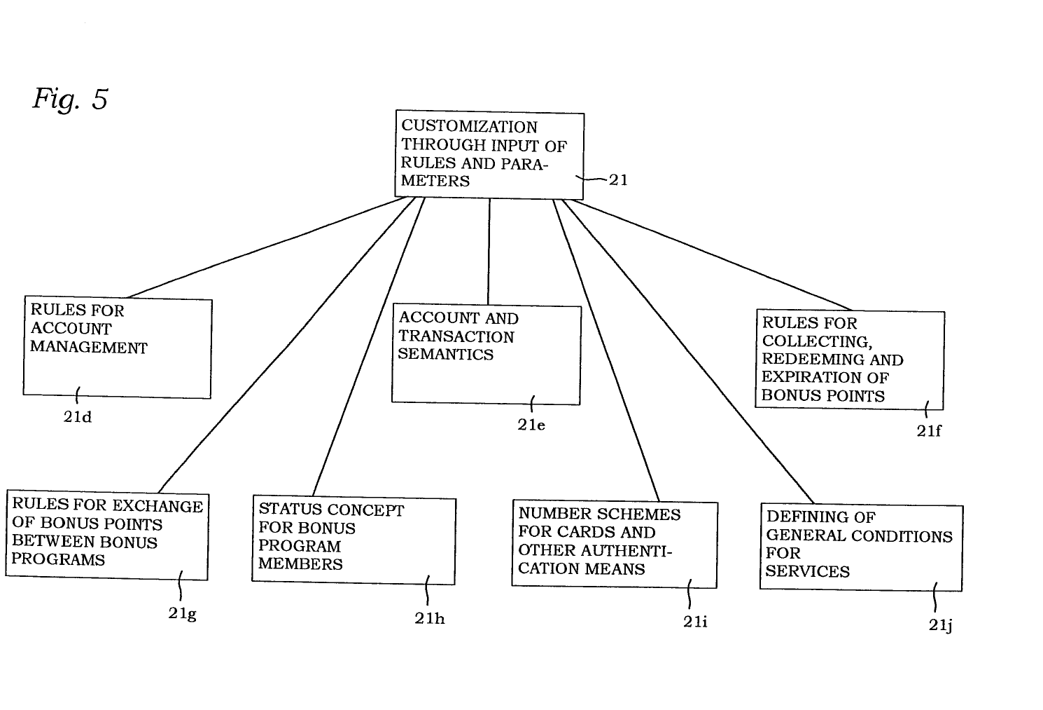

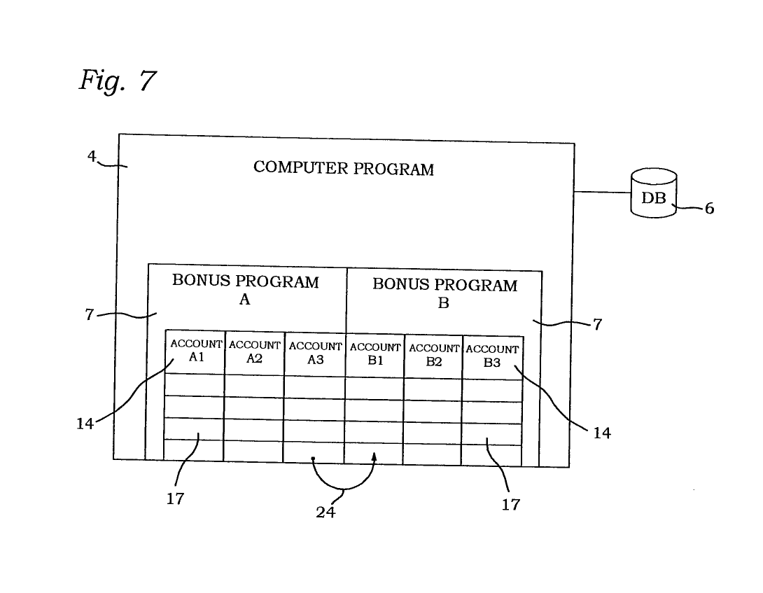

FIG. 5 shows a diagram similar to FIG. 4 for the visualization of additional customization possibilities of the computer program 4, based on seven further customization windows 21d through 21j. The window 21d allows the entry of rules for account administration and account expiration. The window 21e allows the entry of definitions of the account- and transaction semantics. The window 21f allows the entry of rules for collecting, redeeming, and expiration of bonus points. The window 21g allows the entry of rules for exchanging bonus points between bonus programs (see also FIG. 7). The window 21h allows defining a status concept for bonus program members. The window 21i allows defining number schemes for cards and other authentication means. The window 21j serves to define contextual conditions for services. Further customization windows are provided accordingly in various embodiments, allowing the input of rules and definitions with respect to additional above described points and aspects of the bonus system, and thus also with respect to runtime without recompiling the computer program 4.

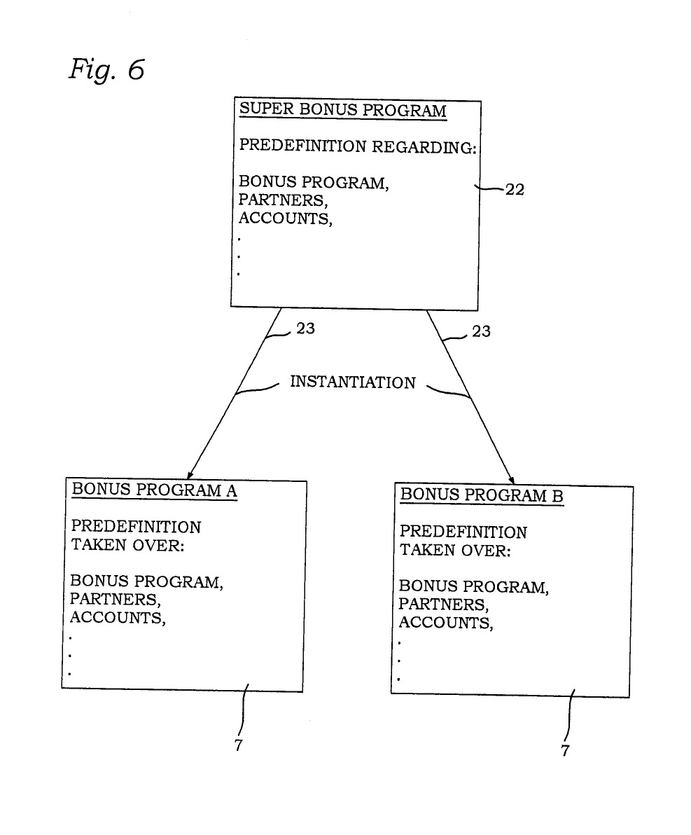

FIG. 6 visualizes a mechanism realized in some embodiments, through which a simple starting point can be provided for the subsequent customization. In the computer program 4 representing the bonus system 1, a predefinition of a bonus program is provided, including predefinitions, e.g. with respect to the said points, bonus program, partner, accounts, etc. This “super bonus program” designated “22” in FIG. 6 bestows these predefinitions onto actual bonus programs 7 upon their instantiation 23. The super bonus program 22 and the bonus programs 7 (e.g. bonus program A and bonus program B in FIG. 6) thus are in a super program relationship with each other. The predefinitions, which were taken over form the starting point for further customization.

FIG. 7 illustrates the ability of the computer program 4 to transfer bonus points collected in a bonus program 7 to another bonus program. According to FIG. 1, in FIG. 7 the two bonus programs A and B are illustrated in an exemplary manner. In the context of these two bonus programs, three bonus point accounts 14 are operated each in an exemplary manner, thus A1, A2, A3 and B1, B2 and B3. As illustrated in FIG. 2, these accounts are represented through one relation 14 each with datasets 17. As it has been explained with reference to FIG. 1 the two bonus programs A and B run on the same platform. The computer program 4 is provided so that it allows a transfer of the bonus points acquired in a bonus program to an account of another bonus program through a bonus program transcending rebooking 24. In the example illustrated in FIG. 7, this rebooking is performed from the account A3 to the account B1. Since both bonus programs A and B run on the same platform (and they are institutions of a super bonus program), this transfer 24 can be performed within the computer program 4 in real time without external data exchange or similar.

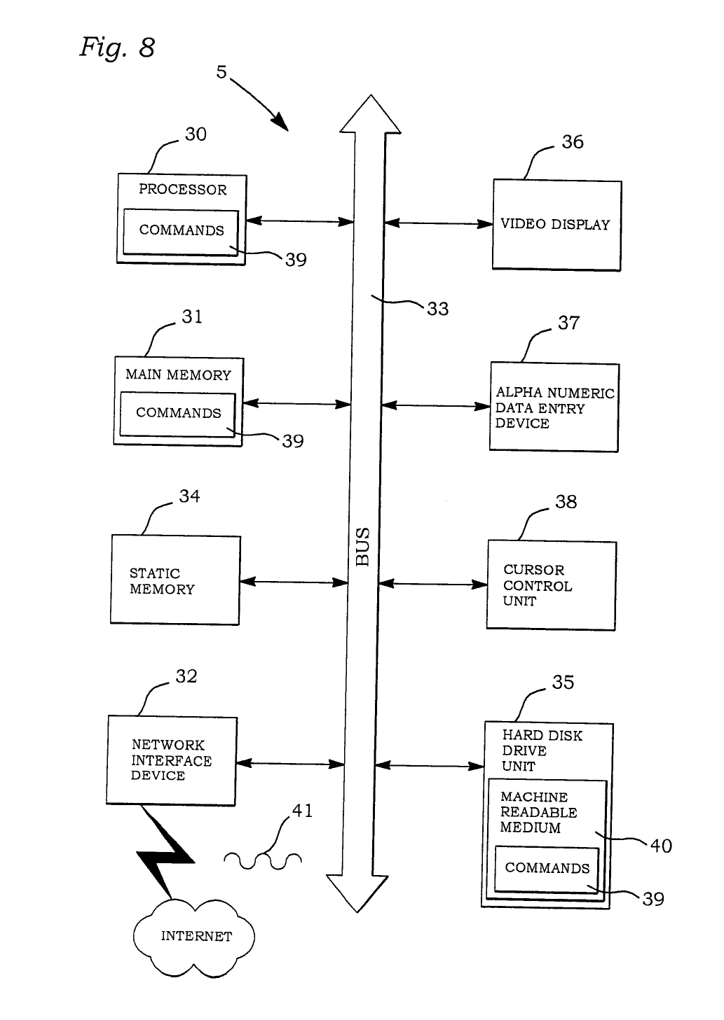

FIG. 8 is a diagram illustration of the server 5 (FIG. 1), which, programmed with the computer program 4, provides the functionality of the architecture of the bonus system 1 of FIG. 1, and is therefore designated here as the bonus computer system 5. Within the bonus computer system 5, a set of commands 39 (forming the computer program 4) can be performed, in order to cause the computer system 5 to provide the functions of customization and execution of the bonus system shown in this description. The bonus computer system 5 comprises e.g. a processor 30, a main memory 31, and a network interface device 32, communicating amongst each other through a bus 33. Optionally, it can furthermore comprise a static memory 34 and a hard drive unit 35. A video display 36, a alphanumeric entry device 37, and a cursor control unit 38 form the hardware side of the user interface 11 (FIG. 1), among others for providing the various customization windows 21 (FIGS. 4 and 5). The network interface device 32 connects the bonus computer system 5, e.g. with the internet, together with respective interfaces, on the sides of the partners 2 they form the connections 9 (FIG. 1). The set of commands 39, this means the software forming the computer program 4, is included entirely or at least partially in or on a machine readable medium 40, e.g. the main memory 31, and/or the processor 30. A machine readable medium 40, on which the software 39 is located, can also be a data carrier, e.g. a non removable magnetic hard drive, or an optical or magnetic removable drive, which is part of a hard disc unit 35. The software 39 can furthermore be transferred or received as a propagated signal 41 through the internet through the network interface device 32.

With respect to further details regarding the input of rules in the context of the customization, the Patent application of the applicant with the title “Rule based Customization”, which is filed in parallel, attorney file L1662049DEP00Lp, is referred to, which is also added to the present documents as an appendix. The contents of this parallel application are hereby incorporated in their entirety into the present application by reference, in particular with respect to the said input of rules.

Overall, the described embodiments provide a customizable bonus system with a large functional scope.

All publications and existing systems mentioned in this description are incorporated by reference.

Though certain procedures, systems and products, which are provided according to the teachings of the invention, were described herein, the scope of this Patent is not limited thereto. To the contrary, this Patent covers all embodiments of the teachings of the invention, which are either verbally or through the doctrine of equivalency, included in the scope of the appended claims.

What is claimed is:

1. A computer program product, comprising program code, stored on a machine readable medium, or provided in the form of a propagated signal, wherein the program code, when executed on a computer system, implements a bonus system, and allows the customizable establishment of bonus programs, wherein several bonus program partners can participate in a bonus program, and wherein bonus program members can collect bonus points in transactions with a bonus program partner, wherein the bonus program comprises the following functions:
defining, activating, and deleting a bonus program within the bonus system;
defining individual bonus program properties and bonus program rules;
defining, activating, and deleting bonus program partners;
settling with bonus program partners; and
establishing properties of bonus program accounts.

2. A computer program product according to claim 1, allowing the operation of several bonus programs on one platform.

3. A computer program product according to claim 1, provided so that a connection between bonus programs can be selected as a super program relationship, in which several bonus program properties of the super bonus program are taken over by bonus programs, or that the bonus programs are programs to be defined independently from each other.

4. A computer program product according to claim 1, provided so that the bonus system can transfer and/or receive data regarding bonus program members, through an interface with a customer relationship management system (CRM system), to and from the CRM system.

5. A computer program product according to claim 1, allowing the definition of bonus program properties with respect to one or several of the following points:
establishing rules for account management;
defining account and transaction semantics;
establishing rules for collecting, redeeming, and expiration of bonus points;
establishing rules for exchanging bonus points between bonus programs;
establishing a status concept for bonus program members;
defining number schemes for cards and other authentication means; and/or
defining general conditions for services.

6. A computer program product according to claim 1, provided so that bonus program members can redeem collected bonus points in the form of bonuses, wherein the different available bonuses and the conditions necessary for receiving them can be defined.

7. A computer program product according to claim 1, provided so that it allows operating parallel accounts with different bonus currencies, and which can give account status information to the respective bonus program member.

8. A computer program product according to claim 1, provided so that it comprises the possibility for computing and booking collected bonus points for different bonus program partners according to freely definable rules.

9. A computer program product according to claim 1, provided so that it allows the definition of an expiration of non used bonus program points after a certain period of time, depending on bonus program rules, the bonus point type, bonus point category, and bonus program member status.

10. A computer program product according to claim 1, provided so that the use of bonus points can be defined in one or several point currencies.

11. A computer program product according to claim 1, provided so that it can provide to bonus program members their respective currently available bonuses, including the bonus points necessary therefore.

12. A computer program product according to claim 1, provided so that different types of bonus program partners can be defined, comprising one or several of the following types:
type, which can only issue bonus points;
type, which can issue compensations from collected bonus points; and
type, which can also issue member identifications.

13. A computer program product according to claim 1, provided so that various business locations and attributes can be defined for a bonus program partner, characterizing the business locations in the bonus program.

14. A computer program product according to claim 1, provided so that compensations for services can be defined, which are provided for partners.

15. A computer program product according to claim 1, provided so that marketing campaigns can be managed in the context of the bonus system, wherein the campaign management comprises one or several of the following points:
defining campaigns with respect to campaign names, manner of campaign publications, registration period, activation period, transaction type promoted, kind of rewards, member groups entitled to participation.

16. A computer program product according to claim 1, provided so that the establishment of new members, including the management and generation of aliases, membership cards and other authentication means can be defined through rules.

17. A computer program product according to claim 1, provided so that a function can be defined, through which a common bonus point account can be assigned to several bonus program members.

18. A computer program product according to claim 1, provided so that one or several data check- or purging functions can be defined from the following list:
identification and consolidation of double memberships;
identification and consolidation of joint households;
checking of mailing addresses;
checking of telephone numbers; and
checking of bank information.

19. A computer program system for hosting a bonus system, allowing the customizable establishment of bonus programs, wherein several bonus program partners can participate in a bonus program, and wherein bonus program members can collect bonus points in transactions with a bonus program partner, wherein the bonus system comprises the following functions:
defining, activating, and deleting a bonus program within the bonus system;
defining individual bonus program properties and bonus program rules;
defining, activating, and deleting bonus program partners;
settling with bonus program partners; and
establishing properties of bonus program accounts.
